(19) United States
(12) Patent Application Publication
(10) Pub. No.: US 2018/0107380 A1
(43) Pub. Date: Apr. 19, 2018

(54) SYSTEM AND METHOD FOR KEY AREA CORRECTION

(71) Applicant: Samsung Electronics Co., Ltd., Suwon-si (KR)

(72) Inventors: Barath Raj KANDUR RAJA, Bangalore (IN); Ankur AGARWAL, Haryana (IN); Chunbae PARK, Suwon-si (KR); Harshavardhana POOJARI, Gangolli (IN); Sungkee KIM, Hwasung-si (KR); Vibhav AGARWAL, Pilani (IN); Youngseol LEE, Suwon-si (KR); Ishan VAID, Himachal Pradesh (IN); Raju Suresh DIXIT, Bangalore (IN); Dwaraka Bhamidipati SREEVATSA, Bangalore (IN); Sanjay KAR, Kolkata (IN); Sibsambhu KAR, Kolkata (IN); Vanraj VALA, Bangalore (IN); Yashwant Singh SAINI, Rajasthan (IN)

(21) Appl. No.: 15/784,766

(22) Filed: Oct. 16, 2017

(30) Foreign Application Priority Data
Oct. 14, 2016 (IN) 201641035228

(51) Int. Cl. G06F 3/0488; G06F 3/041; G06F 3/0484

(52) U.S. Cl. CPC G06F 3/04886; G06F 3/0482; G06F 3/04845; G06F 3/0416

(57) ABSTRACT

An electronic apparatus for providing an on-screen keyboard including a plurality of keys are provided. The electronic apparatus comprises a touch interface configured to receive a touch input of a user and a processor configured to, in response to the touch input being received though the touch interface, determine a touch area where the touch input is received, in response to the plurality of keys are included in the touch area, identify a key corresponding to a touch pattern of the user among the plurality of keys, and display the identified key on a display of the electronic apparatus.

### CROSS-REFERENCE TO RELATED APPLICATION(S)

This application claims the benefit under 35 U.S.C. § 119(a) of an Indian provisional patent application filed on Oct. 14, 2016 in the Indian Intellectual Property Office and assigned Serial number 201641035228, and of an Indian patent application filed on Oct. 12, 2017 in the Indian Intellectual Property Office and assigned Serial number 201641035228, the entire disclosure of which is hereby incorporated by reference.

### TECHNICAL FIELD

The present disclosure relates to touch recognition. More particularly, the present disclosure relates to a system and method for key area correction (KAC).

### BACKGROUND

Touch pattern on a touch screen of an electronic device varies based on Ergonomics. Touch pattern varies for every User. Sometimes Touch pattern varies for the same user based on varying postures, style, size of the electronic device, and the like. For every key on the touch screen, a user touches the key at particular spot based on ergonomics, and such spot is called as key area. The key area is dynamically changed based on Ergonomics, and thus reduces typographical errors, and improve prediction accuracy. Further, key area is changed according to the user's touch habits without any change in layout of the keypad/keyboard.

An existing art talks about modifying key area based on usage pattern, includes monitoring typographical usage, and includes monitoring frequency of usage of combination of keys. The existing art talks about modifying key region such as Space, Size, Shape, and the like.

Further, another existing art talks about keys having fixed display size and adjustable un-displayed hit region. The existing art further talks about updating size of adjustable hit regions based on sequence of characters corresponding to individual touch points. The existing art talks about covering neighboring keys logic for example, when ‘r’ is typed, characters ‘r, e, d, f, t’ are considered.

FIG. 1 is a schematic diagram 100 illustrating considering a character when a touch is detected between two or more-character keys, according to an existing art.

Referring to FIG. 1, user is handling a mobile phone 102 and typing on keyboard of the mobile phone 102. All the keys of the characters have pre-defined size and region, wherein upon touching within the pre-defined region, processor of the mobile phone 102 detects the user touch and identifies the character, has typed. For instance, at 104, characters J and K are next to each on the keyboard, and have pre-defined touch region, shown as white area and Static moving or variable area, shown as grey area. If the user touches on a grey area next to the pre-defined white area of character J, then the mobile phone 102 identifies that that user has touched the character J and displays character J on display. At instance 106, user has touched between touch regions of character J and K, the processor finds it difficult to identify the character based on the touch. Therefore, grey area can be considered as dynamic moving or variable area, wherein based on various factors such as ergonomics, grammar, and the like, the processor of the mobile phone 102 identifies the character as K and displays the same on the display of the mobile phone 102.

Further, another existing art talks about pressing keys on the touch based on Ripple effect logic. In some cases, selected key will be obvious and will not work well. The touch pattern doesn't take into account previous key touch position and the finger used for selecting current and previous keys. Also, longer context is not taken into account for providing character predictions. Thus, there is a need for a system and method that addresses the herein above-mentioned issues and problems and attempt to provide solutions.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for key area correction (KAC).

In accordance with an aspect of the present disclosure, a method for providing a character input in a keyboard is provided. The method includes operations of receiving a touch input for a first key, identifying a touch location on the keyboard, wherein the touch location falls within an overlapping vicinity of one or more adjacent keys, analyzing, by an interpolation module, the touch location in comparison with pre-stored touch locations for the first key, determining an intended character for the first key based on the analysis, and rendering the intended character on a display screen.

In accordance with another aspect of the present disclosure, the analyzing of the touch location is performed using at least one of, but not limited to, a key area correction (KAC) model, a character language model (CLM), or a contextual CLM (CCLM), without departing from the scope of the present disclosure.

In accordance with another aspect of the present disclosure, the KAC model includes bi-gram position-aware touch model (BPTM), wherein touch distribution for the current key varies based on touch position of the previous key, and the finger used for selecting current and previous keys.

In accordance with another aspect of the present disclosure, the KAC model includes a bi-gram position-aware posture model (BPPM), wherein a touch distribution for a current key varies based on user ergonomics, a touch position of a previous key for the identified ergonomics, and a finger used for selecting current and previous keys.

In accordance with another aspect of the present disclosure, the analyzing of the touch location using the KAC model includes receiving a touch input on the first key from a user, identifying the touch distribution on the keyboard, setting one or more zones for each key, wherein the one or more zones includes a protection area, semi-protection area and variable area, identifying all the neighboring keys of touch position, deriving a final probability of the first key and the neighboring keys using KAC model, CLM, and CCLM, and outputting the intended characters based on a priority.

In accordance with another aspect of the present disclosure, the deriving of the final probability of the keys includes contextual interpolation of probabilities from at least one of KAC model, CLM and CCLM.

In accordance with another aspect of the present disclosure, the touch pattern on each key is varied based on one of, but not limited to, ergonomics, user style, varying posture, and the like, without departing from the scope of the disclosure.

In accordance with another aspect of the present disclosure, the touch model is adapted by the user device based on at least one of, but not limited to, keyboard dimensions, device configuration, change in device orientation, fingers used for providing touch input, change in hand posture, or the like, without departing from the scope of the disclosure.

Another aspect of the present disclosure includes creating a plurality of KAC preloaded models which includes collecting user input data, deriving separate KAC models for different ergonomics, and preloading the derived KAC models to the keyboards.

Another aspect of the present disclosure includes creating a KAC personalized user models which includes steps of, but not limited to, tracking information on user input on the keyboard, identifying ergonomics of the user, and creating personalized KAC model for the identified ergonomics of the user.

Another aspect of the present disclosure includes identifying the touch location based on the KAC model which includes activating a device keyboard by the user, loading a pre-stored KAC model as a part of the device keyboard based on one or more touch parameters, receiving a touch input on the first key from the user, recognizing user touch ergonomics, identifying the KAC model based on the ergonomics by comparing the KAC model and the user input style, and loading the identified KAC model.

Another aspect of the present disclosure includes analyzing the touch location using character language model (LM) which includes receiving a user touch input on a first key of the keyboard, identifying current and neighboring characters based on touch position, loading the character LM, interpolating Preload Character LM and User Character LM, prioritizing a current character and the neighboring keys, and outputting the character corresponding to the first key on the display screen.

Another aspect of the present disclosure includes analyzing the touch location (using a contextual character language model (CCLM)) which includes receiving a user touch input on a first key of the keyboard, identifying the touch position of neighboring keys of the first key, identifying previous word(s) and current string, interpolating the preloaded LM and user specific LM and return word predictions, creating the contextual character language model, prioritizing a current character and the neighboring keys, and outputting the character corresponding to the first key on the display screen.

Another aspect of the present disclosure includes creating a character N-gram LM which includes providing a word N-gram LM comprising a plurality of preloaded n-gram entries, normalizing probabilities of the n-gram entries, creating N-gram LM using statistical modeling, obtaining a user input on the keyboard, training the character N-gram LM based on the user input, interpolate the preloaded LM and the user LM, and prioritizing the keys based on the interpolation.

According to another embodiment of the present disclosure, a method of forecast the probability for the next input character based on the current input characters is provided. The method includes steps of loading a key area correction (KAC) model, setting a key area and a protection area for each key of a keyboard, and checking if the user touches the protection area of a key.

According to another embodiment of the present disclosure, an electronic apparatus (eg. a user equipment (UE)) for providing a character input in a keyboard is provided. The UE includes a touch interface configured to receive a touch input for a first key, and identify a touch location on the keyboard, wherein the touch location falls within an overlapping vicinity of one or more adjacent keys. Further, the UE includes an interpolation module configured to analyze the touch location in comparison with pre-stored touch locations for the first key, at least one processor configured to determine an intended character for the first key based on the analysis, and a display screen for rendering the intended character.

The foregoing has outlined, in general, the various aspects of the disclosure and is to serve as an aid to better understanding a more complete detailed description which is to follow. In reference to such, there is to be a clear understanding that the present disclosure is not limited to the method or application of use described and illustrated herein. It is intended that any other advantages and objects of the present disclosure that become apparent or obvious from the detailed description or illustrations contained herein are within the scope of the present disclosure.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating considering a character when a touch is detected between two or more character keys, according to the related art;

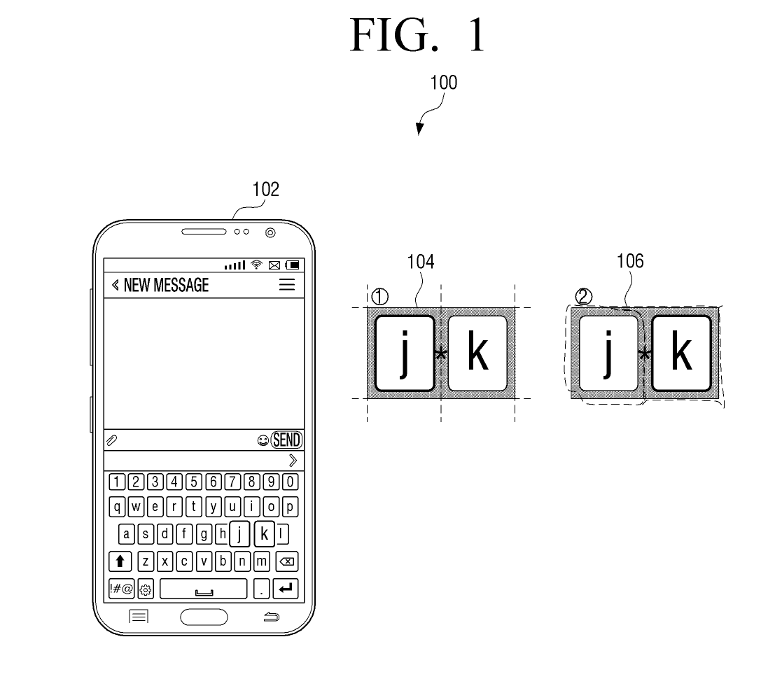

FIG. 2 is a schematic flow diagram illustrating a method for providing a character input in a keyboard, according to an embodiment of the present disclosure;

FIG. 3 is a schematic diagram illustrating a use case of identifying touch input and displaying character using key area correction (KAC) method, according to an embodiment of the present disclosure;

FIG. 4 is a schematic diagram illustrating comparison between key areas before and after correction using BPTM, according to an embodiment of the present disclosure;

FIG. 5 is schematic diagram illustrating various uses illustrating KAC using BPTM, according to an embodiment of the present disclosure;

FIG. 6 is a schematic flow diagram illustrating a method for providing a character input in a keyboard using BPTM, according to an embodiment of the present disclosure;

FIG. 7 is a schematic flow diagram illustrating a method for providing a character input in a keyboard using character language model (CLM), according to an embodiment of the present disclosure;

FIG. 8 is a schematic flow diagram illustrating a method for providing a character input in a keyboard using contextual character language model (CLM) using recurrent neural network (RNN) long short term memory (LSTM) model, according to an embodiment of the present disclosure;

FIG. 9 is a schematic diagram illustrating method for providing a character input in a keyboard using ergonomics and character language model (CLM), according to an embodiment of the present disclosure;

FIG. 10 is a schematic diagram illustrating different ergonomics used for entering characters using keyboard, according to an embodiment of the present disclosure;

FIG. 11 is a schematic diagram illustrating various touch model adaptations on user equipment (UE) for typing, according to an embodiment of the present disclosure;

FIG. 12 is a schematic diagram illustrating backing up and syncing of the touch model and CLM, according to an embodiment of the present disclosure; and

FIG. 13 is a schematic block diagram illustrating UE 1300 for providing a character input in a keyboard, according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure provides a system and method for key area correction (KAC). In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following detailed description is, therefore, not to be taken in a limiting sense, and the scope of the present disclosure is defined only by the appended claims.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure provides a system and method for key area correction (KAC). The present disclosure illustrates method and system for identifying key/character the user intended to input based on user's usage pattern and character that region around one or more characters on keyboard/keypad. The present disclosure is described with respect to a user device/UE, wherein the UE can be any of the known electronic devices, such as, but not limited to, mobile phone, laptop, tablet, smart device, and the like that has touchpad, keypad/keyboard for inputting characters, without departing from the scope of the disclosure.

According to an embodiment of the present disclosure, a method for providing a character input in a keyboard comprises steps of a touch interface receiving a touch input for a first key. A user of UE touches on a touch region on his screen to touch the first key, thereby entering a character. The touch of the user is sensed by the touch interface and the touch input of the first key received. In an embodiment of the present disclosure, the touch screen of the UE that comprises of a keyboard that receives touch input can be at least one of, but not limited to, capacitance touch screen, inductive touch screen and the like, and the person having ordinarily skilled in the art can understand that UE with any of the known touch screen with touch input receiving capability can be used without departing from the scope of the disclosure.

Further, the method comprises of identifying a touch location on the keyboard, wherein the touch location falls within an overlapping vicinity of one or more adjacent keys. Upon receiving the touch input, a processor identifies the touch location on the keyboard. Upon identifying the touch location, the processor identifies that the touch location falls within overlapping vicinity of one or more adjacent keys.

Further, the processor analyzes the touch location in comparison with pre-stored touch locations for the first key. Upon identifying that the touch location is within overlapping vicinity of one or more adjacent keys, the processor accesses pre-stored touch location information with respect to the first key and compares the touch location information associated with the first key received from the keyboard against the pre-stored touch location information. Analyzing of the touch location includes interpolation of the touch location using one or more pre-defined methods. In an embodiment of the present disclosure, the interpolation performed by the processor can be dynamic interpolation, which is described herein later. In an embodiment of the present disclosure, analyzing the touch location is performed using at least one of, but not limited to, a Key Area Correction (KAC) model, a Character Language model (CLM), a contextual CLM, and the like.

In an embodiment of the present disclosure, the KAC model comprises of Bi-gram Position-aware Touch Model (BPTM) where touch distribution for the current key varies based on touch position of the previous key, and the finger used for selecting current and previous keys. In an embodiment of the present disclosure, the KAC model further comprises of bi-gram Position-aware Posture Model (BPPM) wherein the touch distribution for the current key varies based on user ergonomics, touch position of the previous key for the identified ergonomics, and the finger used for selecting current and previous keys. In an embodiment of the present disclosure, the touch pattern on each key is varied based on at least one of, but not limited to, ergonomics, user style, varying posture, and the like, without departing from the scope of the disclosure. In an embodiment of the present disclosure, user posture can vary during different situations such as, but not limited to, standing, sitting, travelling in car, lying down, walking, and the like. In another embodiment of the present disclosure, user style of holding the UE can vary such as, but not limited to, one hand, both hand, the way user holds the device when it is having s-view/flip cover, and the like, without departing from the scope of the disclosure. In another embodiment of the present disclosure, the user postures/styles are identified using touch distribution data, and by classifying and storing them in multiple groups, without departing from the scope of the disclosure.

According to an embodiment of the present disclosure, method analyzing the touch location using the KAC model comprises steps of receiving a touch input on the first key from the user. Upon receiving the touch input, the touch distribution on the keyboard can be identified. Upon identifying the touch distribution, one or more zones can be set for each key, wherein the one or more zones comprise of a protection area, semi-protection area and variable area. Further, the method comprises of identifying all the neighboring keys of touch position. Further, the method comprises of deriving a final probability of the first key and the neighboring keys using KAC model, CLM, CCLM. According to another embodiment of the present disclosure, deriving final probability of the keys comprises of contextual interpolation of probabilities from at least one of KAC model, CLM and CCLM. Based on the frequency of using vocabulary words, weightage of KAC model, CLM and CCLM probabilities can be interpolated.

For instance, when user is using vocabulary word, CLM and CCLM probabilities are given more weightage, whereas when the user is using out of vocabulary (OOV) words, based on frequency of OOV usage, probability from KAC model is given more weightage. Further, the method comprises of outputting the intended characters based on a priority.

In an embodiment of the present disclosure, the interpolation of one or more touch location in KAC can be performed as below:

final KAC probability of a character is calculated as shown below:

P(KAC)=p(Lᵢ|(xᵢ, yᵢ), Lᵢ₋₁, Lᵢ₋₂, w₁ⁱ)

Where, Lᵢ is the current letter to be predicted,

Lᵢ₋₁ and Lᵢ₋₂ is the previous character sequence,

w₁ⁱ is the word sequence,

And (xᵢ, yᵢ) is user touch position.

Similarly, final BPTM, CLM and CCLM probabilities are calculated as shown below:

P(BPTM)=p(Lᵢ|(xᵢ₋₁, y₁₋₂), Lᵢ₋₁)

P(CLM)=p(Lᵢ|Lᵢ₋₁, Lᵢ₋₂)

P(CCLM)=p(Lᵢ|w₁ⁱ)

Further, the CLM is interpolated and CCLM with CIF as CCLM Interpolation Factor and PCLM and UCLM with UIF as UCLM Interpolation Factor:

P(KAC)=P(BPTM)*((CIF*P(CCLM))+((1-CIF)*P(CLM)))

P(CLM)=UIF*P(UCLM)+(1-UIF)*P(PCLM)

According to another embodiment of the present disclosure, during contextual interpolation, the models are interpolated based on user's usage of words. For instance, BPTM is given high priority while entering non-dictionary words whereas CLM/CCLM is given high priority while entering dictionary words.

During correcting key areas, one very important thing that we need to take care of is backspace handling. It is observed from keyboard usage statistics that average length of sentence in a session is ˜20. Therefore, the present disclosure provides a backspace de-queue logic in which queue of size 20 is maintained to store key touch positions. When user presses backspace, touch point entries are deleted from rear end of the queue, which helps in avoiding false training of BPTM.

Deprioritizing character probability is considered when user tries to edit the entered words by using backspace, cursor changes and edit, and the like, as shown in the below table 1:

TABLE 1
Input to be entered: Dexter [Scenario: backspace]

Current text: Dexter

| | | |
|---|---|---|
| Current text: Des\|ter | Without | Utilizing |

| Char | Probability | Prediction | Prediction |
|---|---|---|---|
| S | P1 | First priority | Low priority |
| X | P2 | Second priority | First priority |
| . . . | | | |

The key in the candidate list is de-prioritized when the character is deleted or when probability of correction for the character is high.

Further, the present disclosure discloses backspace learning, wherein when user deletes a character and the new key touch position lies in the variable region of deleted key, CLM probabilities for deleted character sequence are reduced.

Further, the method for providing a character input in a keyboard comprises of a processor (e.g., at least one processor) determining an intended character for the first key based on the analysis. Upon determining the intended character for the first key by the processor, the method further comprise of displaying the intended character on a display screen.

In other words, the electronic apparatus according to an example embodiment may include a touch interface capable of receiving a touch input of a user and a processor configured to, in response to a touch input being received through the touch interface, identify a touch area in which the touch input is received, and in response to a plurality of keys being included in the touch area, to identify a key corresponding to a touch pattern of the user from among the plurality of keys and display the identified key on a display of the electronic apparatus.

In addition, the processor may identify a distribution of a plurality of touch inputs received in each of the keys on the on-screen keyboard, and based on the distribution of the touch inputs, generate a key area of each of the keys included in the on-screen keyboard and identify a key corresponding to a touch pattern of the user from among the plurality of keys included in the touch area based on the generated key area.

That is, the processor may change a predetermined key area based on a distribution of touch inputs.

In addition, the electronic apparatus according to an example embodiment may include a different key area according to a means used for touch input.

Specifically, the processor may identify a means used for the touch input based on at least one of an area and position of the touch area, and based on a distribution of the touch inputs, generate the key area.

In this regard, the processor may, in response to an area of an area in which the touch input is received being larger than a predetermined area, identify that the user performs the touch input by using a first means, and in response to an area of an area in which the touch input being smaller than a predetermined area, identify that the user performs the touch input by using a second means.

In addition, the processor may, in response to a touch area being on the lower right side of a predetermined key area, identifying that a right thumb is a means used for the touch input, and in response to a touch area being a lower left of a predetermined key area, identify that a left thumb is a means used for the touch input.

In addition, the processor may, from among a distribution of a plurality of touch inputs, identify a distribution of a touch input corresponding to an identified means, and generate a key area corresponding to the means.

Meanwhile, the processor may also, in response to the number of means being plural, generate a key area corresponding to each of the means based on a distribution of the touch input corresponding to each of the means.

For example, when the user performs a touch input using both of his or her left thumb and right thumb, the processor may identify that the touch input is performed through two input means based on at least one of an area and position of the touch area.

In addition, the processor may, based on a distribution of each of touch inputs respectively corresponding to the means, generate a first key area in an area touched by the left thumb based on a touch distribution corresponding to the left thumb, and generate a second key area in an area touched by the right thumb based on a touch distribution corresponding to the right thumb.

In an embodiment of the present disclosure, the touch model is adapted by the user equipment (UE) based on at least one of, but not limited to, keyboard dimensions, device configuration, change in device orientation, fingers used for providing touch input, change in hand posture, and the like, and the person having ordinarily skilled in the art can understand that any one or more of the above mentioned parameter/condition can be considered while adapting to the touch model with respect to the user, without departing from the scope of the disclosure.

In an embodiment of the present disclosure, KAC model can be dynamically downloaded by UE during typing of the user, wherein the KAC model can be dynamically downloaded from sources such as user profile stored in a database, pre-selected KAC models, commonly used KAC models, and system defined KAC models and the like, without departing from the scope of the disclosure. In another embodiment of the present disclosure, the KAC model can be preloaded in the UE based on, but not limited to, usage pattern, usage history, previous UE other than the current UE used by the user for inputting characters, and the like, without departing from the scope of the disclosure.

In another embodiment of the present disclosure, creating KAC preloaded models comprises of collecting user input data, deriving separate KAC models for different ergonomics, and preloading the derived KAC models to the keyboards.

In another embodiment of the present disclosure, the KAC models can be personalized and saved in the UE. According to an embodiment of the present disclosure, creating a KAC personalized user models comprises of tracking information on user input on the keyboard, identifying ergonomics of the user, and creating personalized KAC model for the identified ergonomics of the user.

According to an embodiment of the present disclosure, identifying the touch location based on the KAC model comprises of steps of activating a device keyboard by the user, loading a pre-stored KAC model as a part of the device keyboard based on one or more touch parameters, and receiving a touch input on the first key from the user. Further, the method comprises of recognizing user touch ergonomics, identifying the KAC model based on the ergonomics by comparing the KAC model and the user input style, and loading the identified KAC model.

According to another embodiment of the present disclosure, analyzing the touch location using character language model (CLM) comprises steps of receiving a user touch input on a first key of the keyboard, identifying current and neighboring characters based on touch position, and loading the character LM. Further, the method comprises of interpolating Preload Character LM and User Character LM, prioritizing a current character and the neighboring keys, and outputting the character corresponding to the first key on the display screen.

According to another embodiment of the present disclosure, analyzing the touch location using a contextual character language model (CLM) comprises of receiving a user touch input on a first key of the keyboard, identifying the touch position of neighboring keys of the first key, and identifying previous word(s) and current string. Further, the method comprises of interpolating the preloaded LM and user specific LM and return word predictions, creating a contextual character language model, prioritizing a current character and the neighboring keys, and outputting the character corresponding to the first key on the display screen.

In an embodiment of the present disclosure, creating a character N-gram LM comprises of providing a word N-gram LM comprising a plurality of preloaded n-gram entries, normalizing probabilities of the n-gram entries, creating N-gram LM using statistical modeling, and obtaining a user input on the keyboard. Further, the method comprises of training the character N-gram LM based on the user input, interpolate the preloaded LM and the user LM, and prioritizing the keys based on the interpolation.

According to another embodiment of the present disclosure, a method of forecast the probability for the next input character based on the current input characters, the method comprises steps of loading a KAC model, setting key area and protection are per key for a keyboard, and checking if the user touches on a protection area.

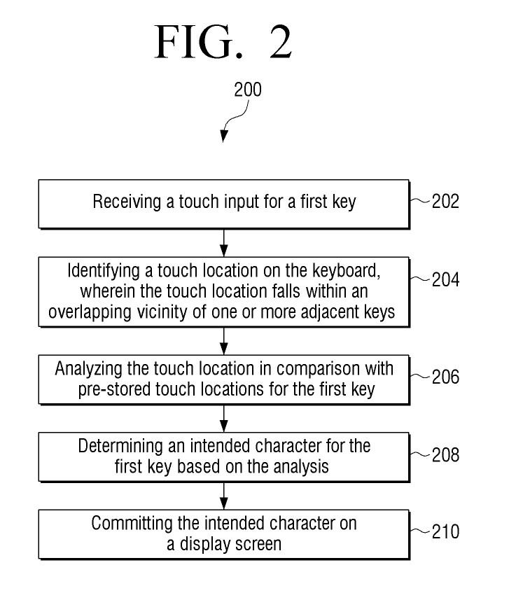

FIG. 2 is a schematic flow diagram 200 illustrating a method for providing a character input in a keyboard, according to an embodiment of the present disclosure. According to the flow diagram 200, at step 202, a touch input is received for a first key. Further, at step 204, a touch location is identified on the keyboard, wherein the touch location falls within an overlapping vicinity of one or more adjacent keys. Further, at step 206, the touch location is analyzed in comparison with pre-stored touch locations for the first key. In an embodiment of the present disclosure, the analysis the touch location is performed using at least one of a Key Area Correction (KAC) model, a Character Language model (CLM), and a contextual CLM. Further, at step 208, an intended character for the first key is determined based on the analysis. Further, at step 210, the intended character is displayed on a display screen of user equipment (UE).

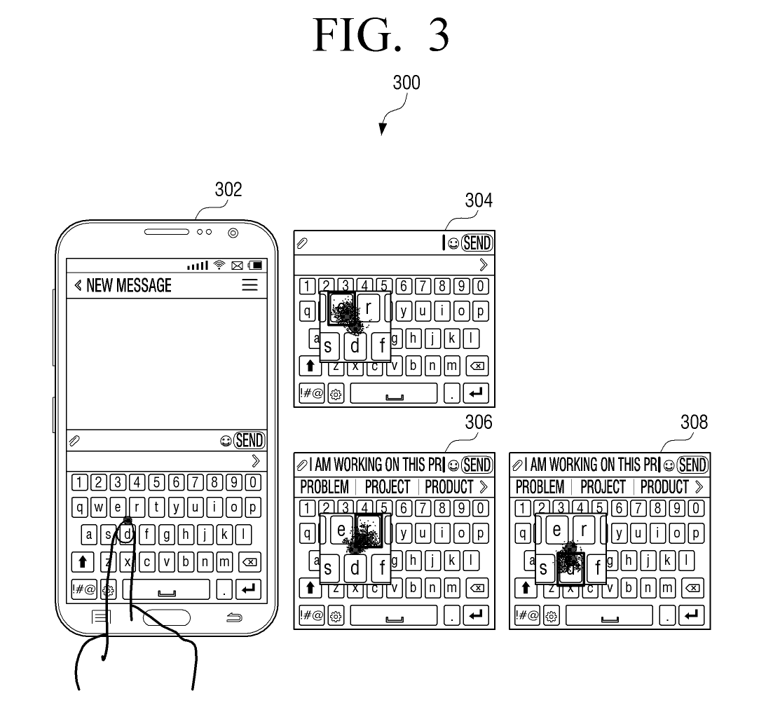

FIG. 3 is a schematic diagram 300 illustrating a use case of identifying touch input and displaying character using key area correction (KAC) method, according to an embodiment of the present disclosure. According to FIG. 3, user of a mobile phone 302 touches on a keyboard, and processor of the mobile phone 302 detect user touch between character E, R and D. In existing arts, as shown in 304, based on touch distribution and key probability, character E would have been selected dynamically.

According to the present disclosure, as shown in 306 and 308, the mobile phone 302 detects location of the user touch, analyzes the present touch location against the previous touch location, which is stored in memory of the mobile phone 302, compares both the touch location and detects the character that user was trying to touch. Based on the detection, at 306 and 308, characters R and D are selected respectively.

At 306, user was trying to type “I AM WORKING ON THIS P” and based on the touch location, the mobile phone 302 identifies that user intends to type a word which is having second character as “R” after character “P” and thus displays the output as “I AM WORKING ON THIS PR”. Similarly, at 308, user is typing “THAT'S BA” and based on the touch location and user's intention, the mobile phone 302 identifies that user is trying to type character D and thus displays “THAT'S BAD”.

According to an embodiment of the present disclosure, the present system and method uses KAC model for analyzing touch location in comparison with pre-stored touch locations for the first key, wherein the KAC model comprises of Bi-gram Position-aware Touch Model (BPTM). According to BPTM, it is observed that touch distribution of same key is different considering touch position of previous key in keyboard layout, and finger used for selecting previous and current keys.

For instance, user is typing using his index finger, and thus types character ‘t’. Now, user intends to type character ‘a’. When user finger moves from previous character T to current character ‘a’, then touch distribution for character ‘a’ is updated accordingly. In another instance, user is typing using his thumb, and thus types character ‘c’. Now, user intends to type character ‘a’. When finger moves from previous character ‘c’ to current character ‘a’, touch distribution for character ‘a’ is updated accordingly. Thus, it can be observed that the user touches in different position of character ‘a’ based on finger movement from previous character, and touch distribution varies for a single key. Therefore, the present disclosure uses BPTM for classifying touch distribution of the key, without departing from the scope of the disclosure.

According to the present disclosure, the BPTM can be preloaded in user equipment (UE) for detecting touch distribution for the particular keys, wherein the BPTM can be created from processed key stroke logs, and preloading the BPTM in the user equipment (UE). Further, the method includes initializing mean/variance for each key that helps in reducing significant typographical error soon after user has started using the UE.

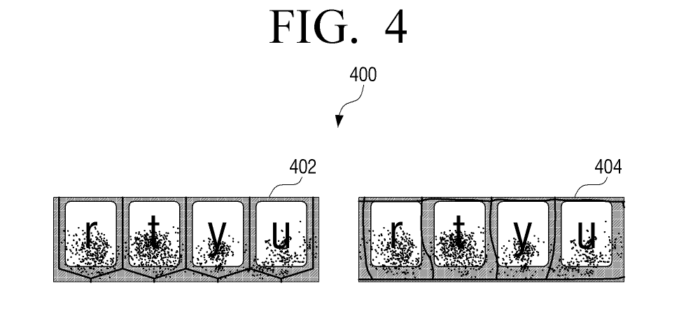

FIG. 4 is a schematic diagram 400 illustrating comparison between key areas before and after correction using BPTM, according to an embodiment of the present disclosure. According FIG. 4, at 402, it can be observed that before correction of keys in keyboard, key area of each keys is defined and set and if user touches anywhere outside the region leads to errors in detecting the keys. After correction, as shown in 404, region of key area with respect to the characters is modified or altered accordingly using BPTM and thus prediction of the keys becomes more efficient with reduced amount of errors.

According to the present disclosure, the BPTM helps in improving prediction accuracy for each character by modifying key regions based on user typing pattern and context. For same touch position, different characters are chosen using proposed method, which in turn improves prediction accuracy. Further, BPTM understands context of the user and where the user is typing the content. Further, BPTM also improves accuracy of continuous input. For same continuous input gesture, more accurate words are predicted. Neighboring keys from (x, y) positions are considered by KAC for determining final key.

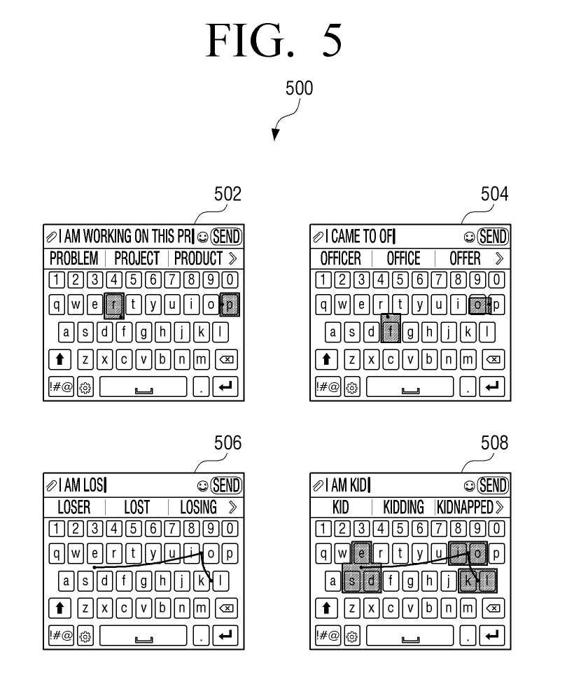

FIG. 5 is schematic diagram 500 illustrating various uses illustrating key area correction using BPTM, according to an embodiment of the present disclosure. FIG. 5 illustrates various use cases, as shown in 502 and 504, for predicting keys while typing each character. Further, 506 and 508 shows before and after comparison of detecting of keys while continuous input, without departing from the scope of the disclosure.

As shown in 502, user is tying “I AM WORKING ON THIS” and the next keys that user equipment (UE) identifies are: first, between characters ‘o’ and ‘p’, and second, between ‘r’, ‘t’, and ‘f’. Upon identifying the touches, BPTM identifies the user touch and detects that user is intended to type characters ‘p’ and ‘r’ and therefore displays “I AM WORKING ON THIS PR” on the display.

Further, as shown in 504, user is tying “I CAME TO” and the next keys that user equipment (UE) identifies are: first, between characters ‘o’ and ‘p’, and second, between ‘r’, ‘i’, and ‘f’. Upon identifying the touches, BPTM identifies the user touch and detects that user is intended to type characters ‘o’ and ‘f’ and therefore displays “I CAME TO OF” on the display.

Further, as shown in 506, before applying BPTM, the user is continuously typing character and has typed “I AM” and the next characters detected from the continuous input are between first ‘l’ and ‘k’, second ‘i’ and ‘o’, and third ‘e’, ‘s’, and ‘d’. Upon detecting the touch location, the UE detects the characters using existing models and identifies the characters ‘l’, ‘o’, and ‘s’ and thus displays “I AM LOS” on the display.

As shown in 508, upon applying BPTM, after correction, the UE identifies that the user is intended to type characters ‘k’, ‘i’, and ‘d’, and thus displays “I AM KID” on the display of the UE.

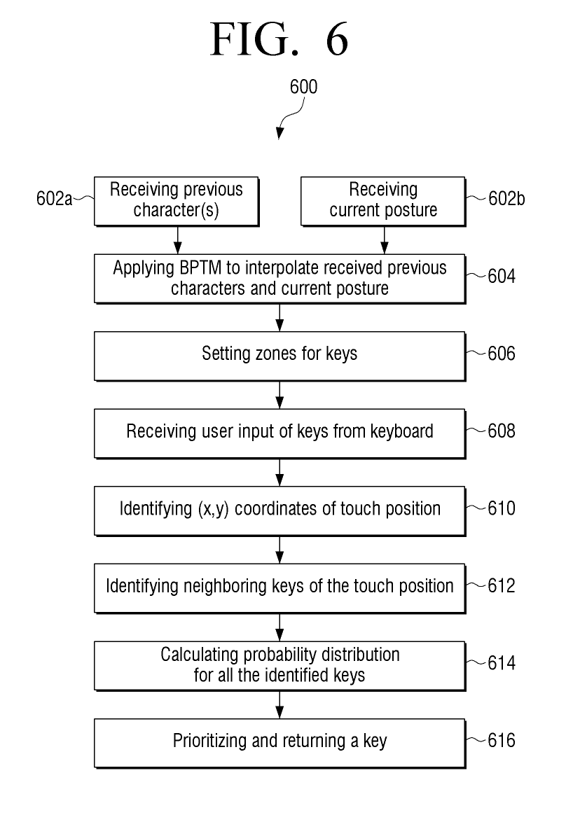

FIG. 6 is a schematic flow diagram 600 illustrating a method for providing a character input in a keyboard using BPTM, according to an embodiment of the present disclosure. According to flow diagram 600, at 602a previous characters are received by user equipment (UE), and at 602b, current posture of the user is received by the UE. Further, at step 604, for the received previous characters and current posture, BPTM can be applied to interpolate using preloaded and current models.

Further, at step 606, zones for keys can be set. In an embodiment of the present disclosure, zones can be any one of, protection area, semi-protection area, variable area and the like, without departing from the scope of the disclosure, wherein protection area is fixed area/zone of the key. Further, at 608, the UE receives user input of keys from keyboard.

Further, at step 610, (x, y) coordinates of the touch position is identified. Further, at step 612, based on the identified touch position from (x, y) coordinates, all the neighboring keys of touch position are found. Further, at step 614, probability distribution for all the identified keys can be calculated based on weight of the zone and distance from touch position to the mean-value of keys. Based on the calculated probability distribution, at step 616, a key can be prioritized and returned for display on display screen of the UE.

According to an embodiment of the present disclosure, the present system and method discloses building user character language model (CLM) or UCLM ally in the UE to adapt user typed text. This is interpolated using the formula:

P_{C}(CHAR|<CLM States>)=y*P_{UCLM}+(1-y)*P_{PCLM}

Where, <CLM States> are previous character sequence, and y is interpolation ratio, y ∈[0,1].

Further, the present system and method discloses dynamic interpolation, wherein to adapt user typing pattern, UCLM weightage can be gradually increased. Further, variation of interpolation weight with respect to total unigram count in UCLM can be calculated using the formulas:

$$y = \{ \begin{matrix}0.3 ; x < {C}_{L} \\ {mx}^{2} + c ; {C}_{L} \leq x \leq {C}_{H} \\ 0.7 ; x > {C}_{H}\end{matrix} \\ m = ( \frac{0.4}{{C}_{H}^{2} - {C}_{L}^{2}} ) and c = 0.3 - ( \frac{0.4}{{C}_{H}^{2} - {C}_{L}^{2}} ) * {C}_{L}^{2}$$

where, m is rate of change of interpolation weight with respect to total characters count in User CLM, 70% and 30% are optimal static values chosen for prioritizing Preload and User Char LM (from corpus observation), CL and CH are constant values which were decided after analyzing benchmarking results.

Further, the method of the present disclosure comprises of normalizing user CLM or UCLM, wherein the UCLM counts are maintained instead of probabilities for memory optimization. To prevent overflow of Uni, Bi and Tri character counts, relative subtraction is applied to all the character sequence frequencies such that conditional probabilities before and after normalization are equal:

$$P ( b \vert a ) = \frac{C ( b Λ a )}{C ( a )} = \frac{C ( ab )}{C ( aa ) + C ( ab ) + … C ( az )}$$

Where C represents count.

After reducing by factor of ‘x’:

$$\begin{matrix}{P}^{′} ( b \vert a ) = \frac{C ( ab ) - xC ( ab )}{[ C ( aa ) - xC ( aa ) ] + [ C ( ab ) - xC ( ab ) ] + … [ C ( az ) - xC ( az ) ]} \\ = \frac{C ( ab ) [ 1 - x ]}{C ( aa ) [ 1 - x ] + C ( ab ) [ 1 - x ] + … C ( az ) [ 1 - x ]} \\ = \frac{C ( ab ) * [ 1 - x ]}{[ 1 - x ] + [ C ( aa ) + C ( ab ) + … C ( az ) ]} ( 0 < x < 1 )\end{matrix}$$

On cancelling (1-x) from numerator and denominator,

P′(b|a)=P(b|a)

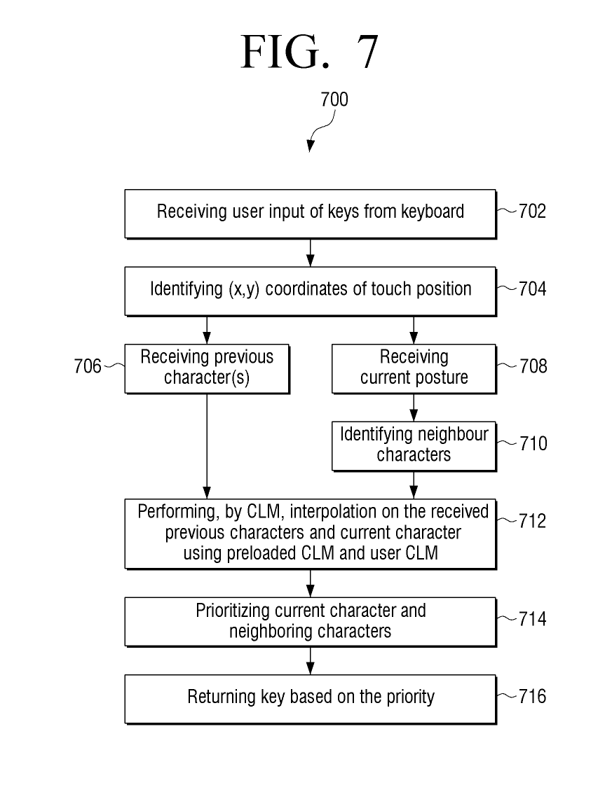

FIG. 7 is a schematic flow diagram 700 illustrating a method for providing a character input in a keyboard using character language model (CLM), according to an embodiment of the present disclosure. According to flow diagram 700, at step 702, user equipment (UE) receives user input of keys from keyboard. Further, at step 704, the UE identifies location of the touch by obtaining (x, y) position on the keyboard.

Based on the identified location of the touch, at step 706, the UE identifies the previous characters entered by the user. Further, at step 708, the UE identifies the current character and at step 710, identifies the neighbor characters. Further, at step 712, the previous characters and current character and neighboring characters around the current character are provided to character language model (CLM) for interpolation, wherein CLM model comprises of preloaded CLM and user CLM, and thus performs interpolation on the received previous characters and current character. Further at step 714, based on the interpolation, current character and neighboring characters are prioritized, and at step 716, a key is returned based on the priority.

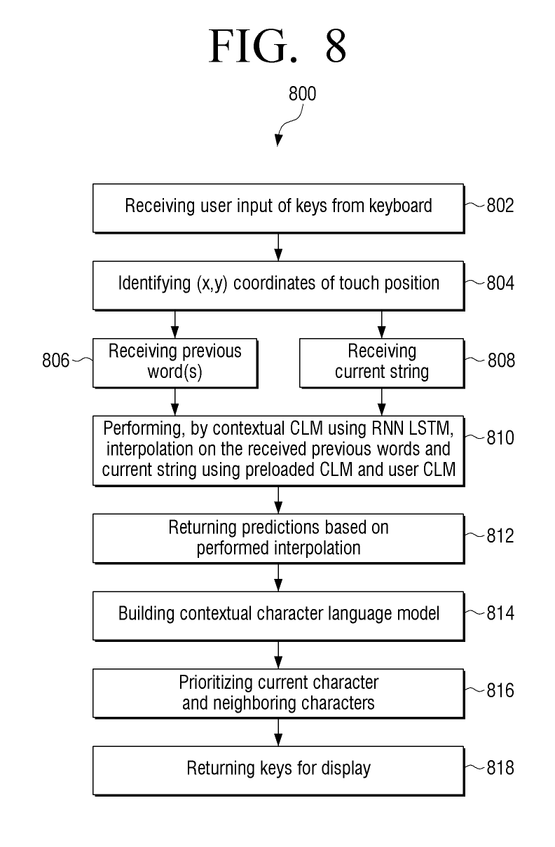

FIG. 8 is a schematic flow diagram 800 illustrating a method for providing a character input in a keyboard using contextual character language model (CCLM) using recurrent neural network (RNN) long short-term memory (LSTM) model, according to an embodiment of the present disclosure. According to the flow diagram 800, at step 802, user equipment (UE) receives user input of keys from keyboard. Further, at step 804, the UE identifies location of the touch by obtaining (x, y) position on the keyboard.

Further, at step 806, one or more previous words are identified and obtained. Further, at step 808, current string of characters is obtained. Further, at step 810, the one or more previous words and current string of characters are provided to contextual CLM using RNN LSTM model, wherein the contextual CLM using RNN LSTM model comprises of preloaded CLM and user CLM. The contextual CLM using RNN LSTM model receives the input and performs interpolation on the received input. Further, at step 812, based on the performed interpolation, returns predictions to the UE.

Based on the received predictions, at step 814, the UE builds contextual character language model (CCLM). Further, at step 816 current character and neighboring characters are prioritized and at step 818, keys are returned to the UE for display.

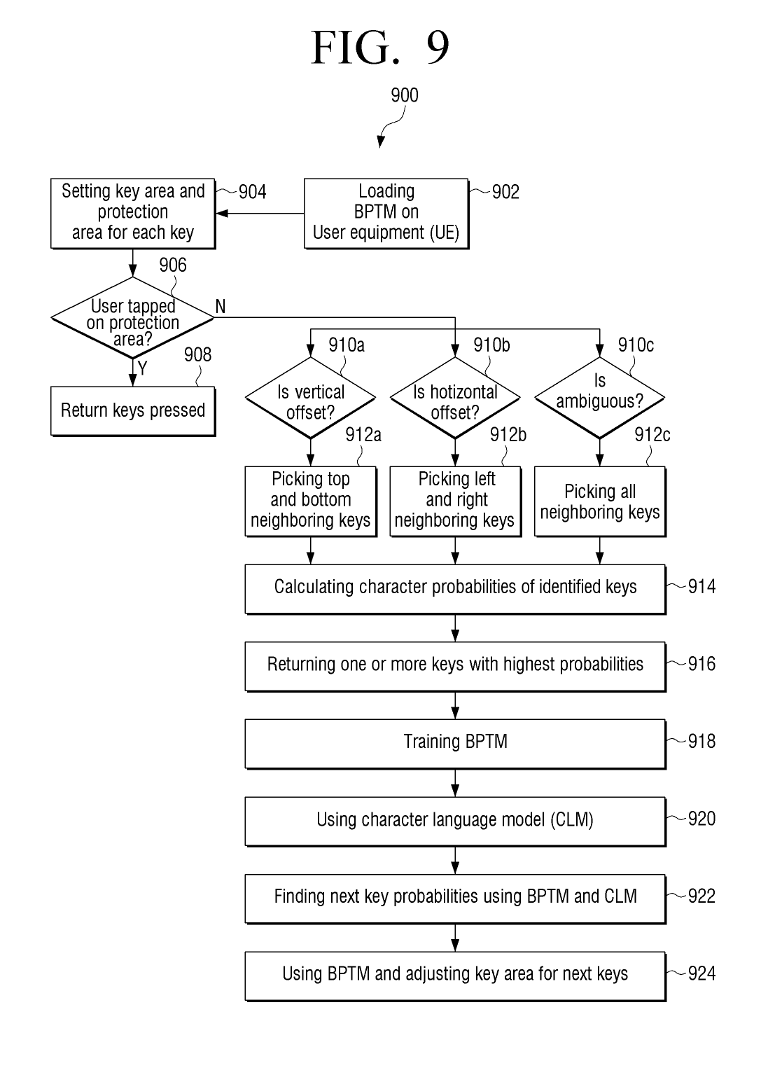

FIG. 9 is a schematic diagram 900 illustrating method for providing a character input in a keyboard using ergonomics and character language model (CLM), according to an embodiment of the present disclosure. According to the flow diagram 900, at 902, a BPTM is loaded on user equipment (UE), and at step 904, key area and protection area for each key is set. Further, at step 906, the UE checks whether the user has tapped on protection area while trying to touch the key. If yes, then at step 908, the UE returns the key pressed by the user. Further, at step 918, BPTM is trained, and at step 920, character language model (CLM) is used. Further, at step 922, based on the BPMT and CLM, next key probabilities are found. Further, at step 924, BPTM is used to and key area for next keys can be adjusted.

If no, then there are three options: at step 910a, the UE checks whether the keyboard is having vertical offset, at step 910b, the UE checks whether the keyboard is having horizontal offset, and at step 910c, the UE checks whether it is ambiguous. If the keyboard is having vertical offset, then at step 912a, the UE picks top and bottom neighboring keys. If the keyboard is having horizontal offset, then at step 912b, the UE picks left and right neighboring keys. If the keyboard is having ambiguity, then at step 912c, all the neighboring keys are picked/identified.

Further, based on the picked neighboring keys, at step 914, character probabilities of identified keys are calculated. Further, at step 916, one or more keys with highest probabilities are returned. Further, at step 918, BPTM is trained, and at step 920, character language model (CLM) is used. Further, at step 922, based on the BPMT and CLM, next key probabilities are found. Further, at step 924, BPTM is used and key area for next keys can be adjusted.

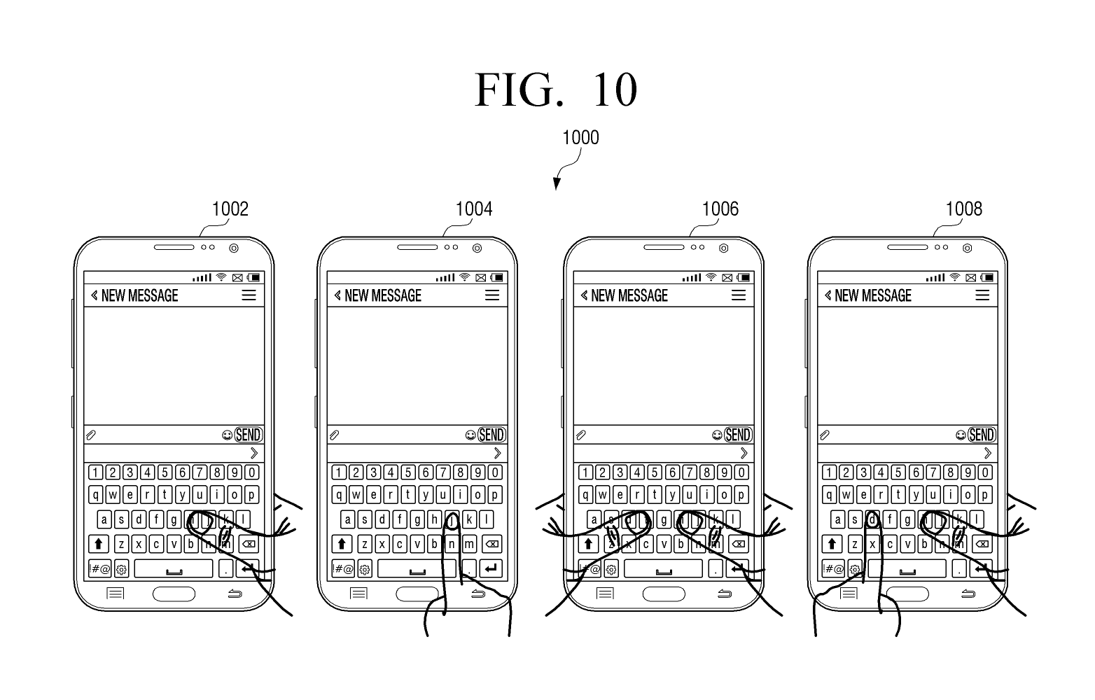

FIG. 10 is a schematic diagram 1000 illustrating different ergonomics used for entering characters using keyboard, according to an embodiment of the present disclosure. Different ergonomics define different styles or characteristics that users use while typing. According to FIG. 10, different ergonomics for typing includes typing using only one thumb, typing using only one index finger, typing using both thumbs from both hands, typing using one index finger and one thumb, and the like. The person having ordinarily skilled in the art can understand that any of the known ergonomics with one or more combination of fingers and style can be used for typing, without departing from the scope of the disclosure.

1002 illustrates ergonomic/style of typing using thumb. Further, 1004 illustrates entering characters using index finger. Further, 1006 illustrates typing using both thumbs of both hands. Further, 1008 illustrates typing using typing using index finger of left hand and thumb of right hand. Any other combination of fingers can be used for typing, without departing from the scope of the disclosure.

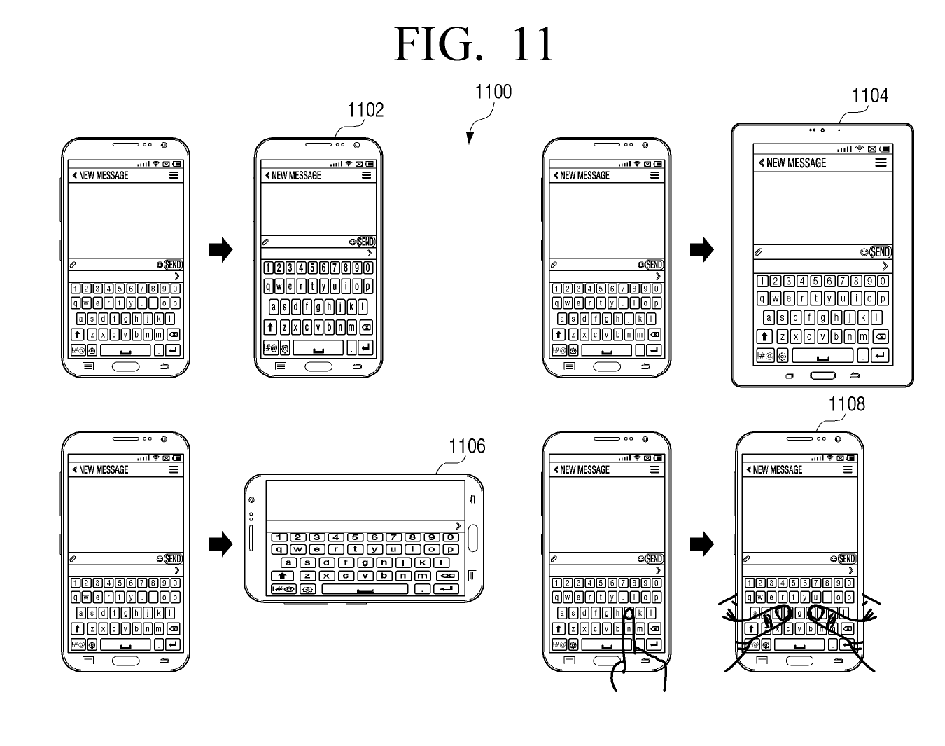

FIG. 11 is a schematic diagram 1100 illustrating various touch model adaptations on user equipment (UE) for typing, according to an embodiment of the present disclosure. According to FIG. 11, at 1102, height of keyboard is changed from h1 to h2. As the height of the keyboard is changed, size of the keys, gap between the keys, protective and semi-protective area between the keys also changes. Upon changing the height of the keyboard, touch positions are scaled based on new keyboard dimension.

At 1104, user changes from UE to another UE. As the UE is changed, one or more ergonomics, width and size of the keyboard, size of the keys, gap between the keys, protective and semi-protective area between the keys also changes. Upon changing the UE, touch positions are adjusted or new touch model is loaded based on device configuration.

At 1106, user changes orientation of the UE from vertical to horizontal, wherein the orientation of the keyboard is also changed from vertical to horizontal. As the orientation of the keyboard is changed, one or more ergonomics, width and size of the keyboard, size of the keys, gap between the keys, protective and semi-protective area between the keys also changes. Upon changing the orientation of the UE, orientation specific touch model is loaded.

At 1108, user changes hand posture while using the UE, wherein the user switches from using only index finger for typing to using both the thumbs from both hands. As the hand posture for typing is changed, posture specific touch model is loaded.

According to an embodiment of the present disclosure, user specific touch model and user specific character language model (CLM) can be backed up and can be saved in a database for future use. In another embodiment of the present disclosure, both user specific touch model and CLM can be saved in a cloud. In another embodiment of the present disclosure, in case of any mishaps or upgradation, the user specific touch model and CLM can be restored to the UE from which it was obtained. In another embodiment of the present disclosure, the user specific touch model and CLM can be downloaded and synced in another UE, wherein the touch model is loaded, adjusted based on configuration of the UE, and the CLM is loaded.

In other words, the processor may, in response to at least one of a size and arrangement of each of keys included in the on-screen keyboard being changed, change the key area to correspond to the changed on-screen keyboard.

In addition, the processor may, in response to a means used for touch input being changed, change the key area to correspond to the changed means. In this regard, the processor may identify whether a means used for a touch input is changed based on at least one from among an area and position of the touch area.

The processor may, in response to a key being selected on the on-screen keyboard, identify a word associated with the selected key based on a language model, and set a size of a key area corresponding to a key included in the word to be larger than a size of a predetermined key area.

For example, when “k” and “i” are selected, the processor may identify that a word associated with the selected key is “kid” based on a language model, and set a key area of “d” to be larger than a predetermined size.

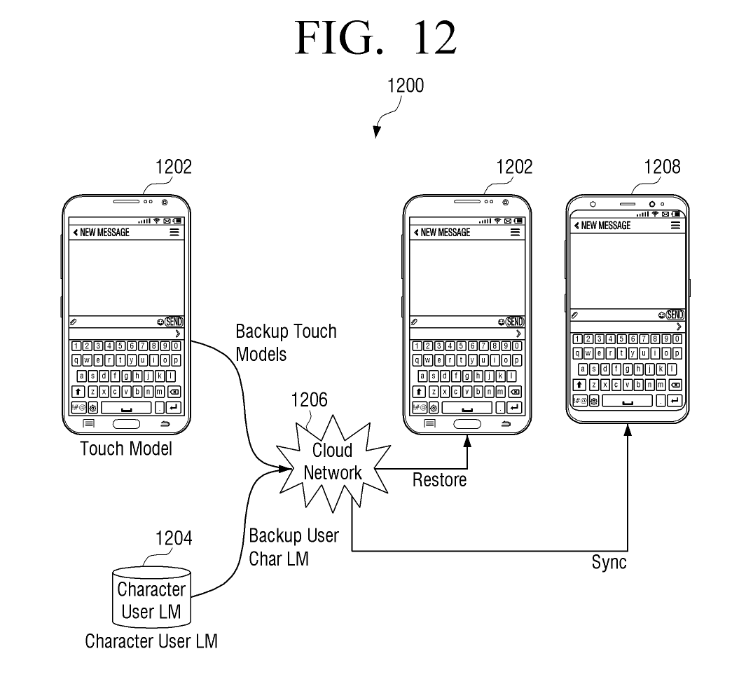

FIG. 12 is a schematic diagram 1200 illustrating backing up and syncing of the touch model and CLM, according to an embodiment of the present disclosure. According to FIG. 12, user specific touch model can be obtained from user equipment (UE) 1202 and character language model (CLM) can be obtained from storage unit/database 1204 that stores CLM. Both the touch model from the UE 1202 and CLM from the database 1204 can be stored on a cloud 1206. Further, if the user wishes to restore, the touch model and CLM on the UE 1202, then both the touch model and CLM can be downloaded and restored on the UE 1202. If the user wishes to sync the touch model and CLM on another UE 1208, then the same can be downloaded on another UE 1208 and synced with the touch model and CLM of another UE 1208.

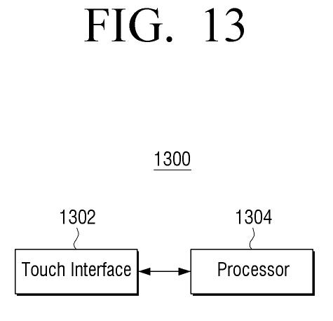

FIG. 13 is a schematic block diagram illustrating user equipment (UE) 1300 for providing a character input in a keyboard, according to an embodiment of the present disclosure. According to the FIG. 13, the UE 1300 comprises of a touch interface 1302, a processor 1304, a display (not shown), and a memory (not shown). According to the present disclosure, the modules/units of the UE 1300 are operatively interconnected to each other. Meanwhile the touch interface (1302) and the display (not shown) are described as separate devices, the touch interface (1302) may be implemented as a display.

According to the present disclosure, the touch interface 1302 of the UE 1300 receives a touch input for one or more keys. In an embodiment of the present disclosure, the touch interface 1302 of the UE 1300 can be inductive touch interface, capacitive touch interface and the like, without departing from the scope of the disclosure. And, the processor 1304 identifies a touch location on the keyboard, wherein the touch location falls within an overlapping vicinity of one or more adjacent keys.

Further, the processor 1304 analyzes the touch location in comparison with pre-stored touch locations for the touched one or more keys. The processor 1304 uses at least one of, but not limited to, a Key Area Correction (KAC) model, a Character Language model (CLM), and a contextual CLM (CCLM) for analyzing the touch location in comparison with pre-stored touch locations for the touched one or more keys, without departing from the scope of the present disclosure. Further, the processor 1306 of the UE 1300 receives the analysis data and determines an intended character for the touched key based on the analysis performed. Further, the display (not shown) displays the intended character based on the determination made by the processor 1306.

Further, the memory (not shown) can store at least one of information associated with the identification of keys pressed by user that includes, but not limited to, one or more analysis information, models used for analysis, previous characters pressed by the user, preloaded CLM, CCLM, KAC model, user CLM, user CCLM, and the like, and the person having ordinarily skilled in the art can understand that the memory (not shown) can store any of the information associated with identifying the character during touching of the key, without departing from the scope of the present disclosure. Further, the memory (not shown) can be present within the UE 1300. In another embodiment of the present disclosure, the memory (not shown) can be present at another location, and can be operatively connected to the UE 1300 over a network. The person having ordinarily skilled in the art can understand that the memory (not shown)can be connected to the UE 1300 irrespective to its location and store, receive, provide and manage information associate with user and the UE 1300, without departing from the scope of the present disclosure.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus for providing an on-screen keyboard including a plurality of keys, the electronic apparatus comprising:
a touch interface configured to receive a touch input of a user; and
a processor configured to,
in response to the touch input being received though the touch interface, determine a touch area where the touch input is received,
in response to the plurality of keys are included in the touch area, identify a key corresponding to a touch pattern of the user among the plurality of keys, and
display the identified key on a display of the electronic apparatus.

2. The electronic apparatus as claimed in claim 1, wherein the processor identifies a distribution of a plurality of touch inputs received in each of keys on the on-screen keyboard, based on a distribution of the touch input, generates a key area of each of keys included in the on-screen keyboard, and identifies a key corresponding to a touch pattern of the user from among a plurality of keys included in the touch area based on the generated key area.

3. The electronic apparatus as claimed in claim 2, wherein the processor determines a means used for the touch input based on at least from among an area and position of the touch area, and generates the key area based on a distribution of the touch input corresponding to the means.

4. The electronic apparatus as claimed in claim 3, wherein the processor, in response to an area of a region in which the touch input is received being larger than a predetermined area, identifies that the user performs the touch input by using a first means, and in response to an area of a region in which the touch input is received being smaller than a predetermined area, identifies that the user performs the touch input by using a second means.

5. The electronic apparatus as claimed in claim 2, wherein the processor, in response to a number of the means being plural, generate a key area corresponding to each of the means based on a distribution of the touch input.

6. The electronic apparatus as claimed in claim 1, wherein the processor, in response to at least one from among a size and arrangement of each of keys included in the on-screen keyboard, changes the key area to correspond to the changed on-screen keyboard.

7. The electronic apparatus as claimed in claim 3, wherein the processor, in response to a means used for the touch input being changed, changes the key area to correspond to the changed means.

8. The electronic apparatus as claimed in claim 1, wherein the processor, in response to a key being selected on the on-screen keyboard, identifies a word associated with the selected key based on a language model, and sets a size of a key area corresponding to a key included in the word to be larger than a size of a predetermined key area.

9. The electronic apparatus as claimed in claim 1, wherein the processor uses at least one from among a key area correction (KAC) model, a character language model (CLM) and a contextual (CLM) for identifying the one key.

10. The electronic apparatus as claimed in claim 9, wherein the KAC model comprises a bi-gram position-aware touch model (BPTM), and
wherein a touch distribution for a current key varies based on a touch position of a previous key, or a finger used for selecting the current key and previous keys.

11. A method for controlling an electronic apparatus providing an on-screen keyboard including a plurality of keys, the method comprising:
receiving a touch input of a user;
identifying a touch area in which the touch input is received;
in response to the touch area including the plurality of keys, identifying a key corresponding to a touch pattern of the user from among the plurality of keys; and
displaying the identified key on a display of the electronic apparatus.

12. The method as claimed in claim 11, wherein the identifying comprises:
identifying a distribution of a plurality of touch inputs received in each of keys on the on-screen keyboard;
generating a key area corresponding to each of keys included in the on-screen keyboard based on a distribution of the touch input; and
identifying a key corresponding to a touch pattern of the user from among a plurality of keys included in the touch area based on the generated key area.

13. The method as claimed in claim 12, further comprising:
identifying a means used for the touch input based on at least one from among an area and position of the touch area,
wherein the generating the key area comprises generating the key area based on a distribution of the touch input corresponding to the means.

14. The method as claimed in claim 13, wherein the determining the means comprises, in response to an area of a region in which the touch input is received being larger than a predetermined area, identifying that the user performs the touch input by using a first means, and in response to an area of a region in which the touch input is received being smaller than a predetermined area, identifying that the user performs the touch input by using a second means.

15. The method as claimed in claim 12, wherein the generating the key area comprises, in response to a number of the means being plural, generating a key area corresponding to each of the means based on a distribution of the touch input.

16. The method as claimed in claim 11, further comprising, in response to at least one from among a size and arrangement of each of keys included in the on-screen keyboard being changed, changing the key area to correspond to the changed on-screen keyboard.

17. The method as claimed in claim 13, further comprising, in response to a means used for the touch input being changed, changing the key area to correspond to the changed means.

18. The method as claimed in claim 11, further comprising, in response to a key being selected on the on-screen keyboard, identifying a word associated with the selected key based on a language model, and setting an area of a key area corresponding to a key included in the word to be larger than a predetermined area.

19. The method as claimed in claim 11, wherein the identifying the key comprises using at least one from among a key area correction (KAC) model, a character language model (CLM) and a contextual CLM.

20. The method as claimed in claim 19, wherein the KAC model comprises a bi-gram position-aware touch model (BPTM), and
wherein a touch distribution for a current key varies based on a touch position of a previous key, or a finger used for selecting the current key and previous keys.
